(19) United States
(12) Patent Application Publication
(10) Pub. No.: US 2024/0352195 A1
(43) Pub. Date: Oct. 24, 2024

(54) PREPARATION METHOD FOR DOUBLE-END-CAPPED POLYSULFONE

(71) Applicant: FUHAI (DONGYING) ADVANCED MATERIAL TECH CO., LTD., Dongying, Shandong (CN)

(72) Inventors: Bibo Shi, Dongying, Shandong (CN); Min Wang, Dongying, Shandong (CN); Guangming Liao, Dongying, Shandong (CN)

(21) Appl. No.: 18/682,435

(22) PCT Filed: Dec. 30, 2021
(86) PCT No.: PCT/CN2021/143156

§ 371 Date: Feb. 8, 2024

(30) Foreign Application Priority Data
Aug. 18, 2021 (CN) 202110945877.8

(51) Int. Cl. C08G 75/23; B01D 71/68

(52) U.S. Cl. CPC C08G 75/23; B01D 71/68

(57) ABSTRACT

The present disclosure relates to the technical field of high polymer materials, and specifically relates to a preparation method for double-end-capped polysulfone, comprising using bisphenol A and 4,4′-dichlorodiphenyl sulfone as reaction monomers, adding an end-capping agent A having a lower activity than bisphenol A, a salt forming agent, and a solvent for reacting until the molecular mass reaches a target molecular mass, adding an end-capping agent B having a higher activity than bisphenol A to continue the reaction, and performing a post-treatment after the reaction is completed to obtain the double-end-capped polysulfone.

### CROSS-REFERENCE TO RELATED APPLICATIONS

The present disclosure claims priority to the Chinese patent application with the filing number “CN202110945877.8” filed on Aug. 18, 2021 with the Chinese Patent Office and entitled “PREPARATION METHOD FOR DOUBLE-END-CAPPED POLYSULFONE”, the contents of which are incorporated herein by reference in entirety.

### TECHNICAL FIELD

The present disclosure belongs to the technical field of high polymer materials, and specifically to a preparation method for double-end-capped polysulfone.

### BACKGROUND ART

Polysulfone resin is a thermoplastic engineering plastic emerging in the mid-1960s, and is a non-crystalline high polymer compound with a molecular main chain containing sulfone groups and aromatic nuclei. Polysulfones generally include three classes, namely, bisphenol A polysulfones, polyphenylsulfones and polyethersulfones. The bisphenol A polysulfones and polyethersulfones in the polysulfones are in wide application due to good thermal stability and dimensional stability, hydrolysis resistance, radiation resistance, flame resistance and so on. However, as the domestic technical level is relatively low, the polysulfone resin has poor appearance performance, low light transmittance, high yellowness, and high crystallinity, and is unacceptable in most cases during practical applications. This problem restricts its development in color and appearance sensitive applications. Different end groups of resin have different heat resistance, for example, a phenolic hydroxyl end group has lower heat resistance than a chloride end group, and the phenolic hydroxyl group is prone to oxidation under high-temperature aerobic conditions to cause yellowing of the resin, and lower the color level.

Therefore, using an end-capping agent becomes an effective method for solving this problem. Most existing patents use methyl chloride as the end-capping agent. Methyl chloride is difficult to diffuse evenly in high-viscosity polymers, and methyl chloride is a flammable, explosive, and toxic gas, and is hazardous. Although some patents have a relatively obvious effect in controlling a molecular weight with use of asymmetric aromatic ketone-based derivatives as end-capping agents, such end-capping agents are difficult to remove, which affects performance of polysulfones. There are also patents using sulfone monochloride as an end-capping agent for polysulfone polymerization. Although sulfone monochloride has a faster reaction speed, sulfone monochloride is not easy to obtain and is prone to depolymerization, which affects later processing and use of polymer.

### SUMMARY

The present disclosure provides a preparation method for double-end-capped polysulfone, in which bisphenol A and 4,4′-dichlorodiphenyl sulfone are used as reaction monomers, an end-capping agent A having lower activity than the bisphenol A, a salt forming agent and a solvent are added for performing reaction until a molecular weight reaches a target molecular weight, an end-capping agent B having higher activity than the bisphenol A is added to continue the reaction, and a post-treatment is performed after the reaction is completed to obtain the double-end-capped polysulfone.

In some embodiments, the following steps are included:

(1) polymerization reaction: using the bisphenol A and 4,4′-dichlorodiphenyl sulfone as the reaction monomers, adding the salt forming agent and the solvent to first perform a salt forming reaction, wherein during the reaction, adding the end-capping agent A having lower activity than the bisphenol A according to a phenolic hydroxyl group content and/or a water content in a reaction system, then heating up to perform the polymerization reaction, when the molecular weight reaching the target molecular weight, adding the end-capping agent B having higher activity than the bisphenol A to continue the reaction, and after the reaction being completed, obtaining a polymerization solution; and

(2) post-treatment: diluting the polymerization solution and then filtering the diluted polymerization solution, then precipitating, crushing, and filtering the filtered polymerization solution, and then washing and drying crushed product to obtain the double-end-capped polysulfone.

In some embodiments, a temperature of the salt forming reaction is 80-120° C., and reaction duration is 3-6 h; a temperature of the polymerization reaction is 160-200° C., reaction duration is 2-8 h, and the reaction is continued for 20-40 min after adding the end-capping agent B having activity higher than the bisphenol A.

In some embodiments, a temperature of the salt forming reaction is 80-120° C., and reaction duration is 3-6 h; a temperature of the polymerization reaction is 150-200° C., reaction duration is 2-8 h, and the reaction is continued for 20-40 min after adding the end-capping agent B having activity higher than the bisphenol A.

In some embodiments, during the salt forming reaction, duration for adding the end-capping agent A is 2-4 h, specifically as follows:

within the first 1 h, the water content in the reaction system is controlled within a range of 1.0-1.5%, and an amount of the end-capping agent A added is 45-60% of a total mass of the end-capping agent A;

within 2-3 h of the reaction, the water content in the reaction system is controlled within a range of 0.45-0.65%, and an amount of the end-capping agent A added is 30-40% of the total mass of the end-capping agent A; and

within 3-4 h of the reaction, the water content in the reaction system is controlled within a range of 0.25-0.35%, and an amount of the end-capping agent A added is 8-20% of the total mass of the end-capping agent A.

In some embodiments, a molar ratio of 4,4′-dichlorodiphenyl sulfone to the bisphenol A is (1.015:1)-(1.2:1), and a water content of both 4,4′-dichlorodiphenyl sulfone and the bisphenol A is less than 0.1%.

In some embodiments, the solvent is one of N,N-dimethylformamide, N,N-dimethylacetamide, N-methyl pyrrolidone or sulfolane, and a water content of the solvent is less than 0.1%.

In some embodiments, a molar ratio of the salt forming agent to the bisphenol A is (1.01:1)-(1.2:1), the salt forming agent is one of K₂CO₃, KHCO₃, Na₂CO₃ or NaHCO₃, and a water content of the salt forming agent is less than 0.1%.

In some embodiments, the end-capping agent A is one of p-nitrophenol, p-hydroxybenzenesulfonic acid or p-hydroxyacetophenone.

In some embodiments, the end-blocking agent B is one of p-aminophenol, p-methylaminophenol or N-(4-hydroxyphenyl) acetamide.

In some embodiments, a molar ratio of the end-capping agent A to the bisphenol A is (0.003:1)-(0.005:1); and a molar ratio of the end-blocking agent B to the bisphenol A is (0.003:1)-(0.006:1).

The present disclosure further provides polysulfone prepared according to any of the methods described above.

The present disclosure further provides use of the polysulfone in a filter membrane.

In some embodiments, the filter membrane includes one of a hollow fiber membrane, a flat sheet membrane, an ion exchange membrane, and a semipermeable membrane.

### DETAILED DESCRIPTION OF EMBODIMENTS

Some embodiments of the present disclosure provide a preparation method for double-end-capped polysulfone, in which bisphenol A and 4,4′-dichlorodiphenyl sulfone are used as reaction monomers, an end-capping agent A having lower activity than the bisphenol A, a salt forming agent and a solvent are added for performing reaction until a molecular weight reaches a target molecular weight, an end-capping agent B having higher activity than the bisphenol A is added to continue the reaction, and after the reaction is completed, synthesized polysulfone is subjected to post-treatment of precipitation, crushing, water washing, and solvent washing, to obtain the double-end-capped polysulfone.

In some embodiments, the preparation method for double-end-capped polysulfone includes following steps:

(1) polymerization reaction: using the bisphenol A (water content<0.1%) and 4,4′-dichlorodiphenyl sulfone as monomers (water content<0.1%), and an alkali metal salt (water content<0.1%) as a salt forming agent, adding a certain amount of a solvent (water content<0.1%) (a solid content is 30-50%) under N₂ protection to react, performing a salt forming reaction (reaction duration is 3-6 h) under 80-120° C., wherein during the reaction, an end-capping agent A having lower activity than the bisphenol A is added according to a phenolic hydroxyl group content and/or a water content in a reaction system, performing a polymerization reaction (2-8 h) at 150-200°° C., for example, 160-200° C., and when a molecular weight reaching a target molecular weight, adding a certain amount of an end-capping agent B to continue the reaction for 20-40 min, to obtain a polymerization solution; and

(2) post-treatment: diluting the polymerization solution to a solid content of 15-20%, performing multiple times of filtration to remove salt and impurities in the polymerization solution, precipitating the filtered polymerization solution in a mixed solution of water and alcohol and crushing the resultant, washing crushed polysulfone powder with water and alcohol multiple times to remove inorganic salt, solvent, unreacted raw materials, capping agents, etc. in the product, and then drying the washed product to obtain the double-end-capped polysulfone.

In some embodiments, in the polymerization reaction in the step (1), the duration of the reaction continued after adding the end-capping agent B may be, for example, 20 min, 22 min, 25 min, 28 min, 30 min, 32 min, 34 min, 35 min, 38 min or 40 min.

In some embodiments, in the post-treatment in the step (2), the polymerization solution is diluted to a solid content that may be, for example, 15%, 16%, 17%, 18%, 19% or 20%.

In some embodiments, during the salt forming reaction, duration for adding the end-capping agent A is 2-4 h, such as 2 h, 2.5 h, 3 h, 3.5 h or 4 h.

In some embodiments, the duration for adding the end-capping agent A is divided as follows: within the first 1 h, the water content in the reaction system is controlled within a range of 1.0-1.5%, such as 1.0%, 1.1%, 1.2%, 1.3%, 1.4% or 1.5%, and the amount of the end-capping agent A added is 45-60%, such as 45%, 47%, 49%, 50%, 52%, 54%, 56%, 58% or 60% of the total mass of the end-capping agent A;

within 2-3 h of the reaction, the water content in the reaction system is controlled within a range of 0.45-0.65%, such as 0.47%, 0.50%, 0.52%, 0.54%, 0.58%, 0.60%, 0.62% or 0.65%, and an amount of the end-capping agent A added is 30-40%, such as 30%, 32%, 34%, 36%, 38% or 40% of the total mass of the end-capping agent A; and

within 3-4 h of the reaction, the water content in the reaction system is controlled within a range of 0.25-0.35%, such as 0.25%, 0.27%, 0.30%, 0.32% or 0.35%, and an amount of the end-capping agent A added is 8-20%, such as 8%, 9%, 10%, 12%, 14%, 16%, 18% or 20% of the total mass of the end-capping agent A.

In some embodiments, the molar ratio of 4,4′-dichlorodiphenyl sulfone to the bisphenol A is 1.015:1-1.2:1, such as 1.015:1, 1.02:1, 1.04:1, 1.06:1, 1.08:1, 1.1:1, 1.12:1, 1.14:1, 1.16:1, 1.18:1 or 1.2:1. Excess 4,4′-dichlorodiphenyl sulfone may effectively reduce the content of phenolic hydroxyl groups in the system. Phenolic hydroxyl end groups have lower heat resistance than chlorine end groups. The phenolic hydroxyl groups are prone to oxidation under high-temperature aerobic conditions to cause yellowing of the resin, and lower a color level. Excess 4,4′-dichlorodiphenyl sulfone is beneficial for generating a high-molecular polymer with an end group being chlorine, which finally reacts with the end-capping agent containing phenolic hydroxyl groups.

In some embodiments, the solvent is one of N,N-dimethylformamide, N,N-dimethylacetamide, N-methyl pyrrolidone or sulfolane. In some embodiments, the solvent is N,N-dimethylacetamide.

In some embodiments, the molar ratio of the salt forming agent to the bisphenol A is 1.01:1-1.2:1, for example, 1.03:1-1.1:1, such as 1.03:1, 1.05:1, 1.07:1, 1.09:1, 1.11:1, 1.12:1, 1.14:1, 1.16:1, 1.18:1 or 1.2:1. In some embodiments, the salt forming agent is an alkali metal salt, being one selected from K₂CO₃, KHCO₃, Na₂CO₃ or NaHCO₃. In some embodiments, the salt forming agent is K₂CO₃.

In some embodiments, the end-capping agent A is one of p-nitrophenol, p-hydroxybenzenesulfonic acid or p-hydroxyacetophenone. In some embodiments, the end-capping agent A is p-hydroxyacetophenone. In some embodiments, the molar ratio of the end-capping agent A to the bisphenol A is 0.003:1-0.005:1, for example, 0.0038:1-0.005:1, such as 0.0038:1, 0.004:1, 0.0042:1, 0.0046:1 or 0.005:1.

In some embodiments, the end-blocking agent B is one of p-aminophenol, p-methylaminophenol or N-(4-hydroxyphenyl) acetamide. In some embodiments, the end-capping agent B is p-aminophenol. In some embodiments, the molar ratio of the end-capping agent B to the bisphenol A is 0.003:1-0.006:1, for example, 0.004:1-0.005:1, such as 0.004:1, 0.0042:1, 0.0044:1, 0.0046:1, 0.0048:1 or 0.005:1.

In the present disclosure, two end-capping agents with different activity are used for end-capping. A compound, the end-capping agent A, having activity slightly weaker than the bisphenol A is used in an early stage of the reaction:

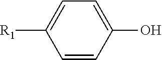

where R₁═—NO₂, —SO₃H, —COCH₃ and other electron withdrawing groups, such that it is not easy to produce double-end-capped small-molecule polymers during the reaction:

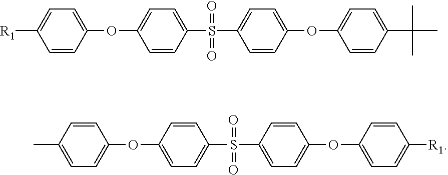

The whole reaction makes the system more conducive to synthesis of a polymer that is capped at one end and uncapped at the other end and can continue the polymerization reaction:

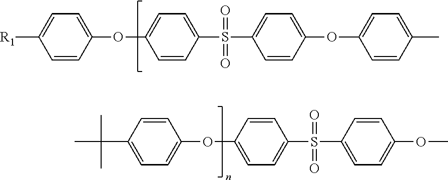

During the use of the end-capping agent A, the present disclosure needs to monitor an extent of reaction of the phenolic hydroxyl groups and a water content generated in real time. According to a theoretical water output amount and an actual water output value, a speed of adding the end-capping agent A is adjusted in real time according to concentration of the phenolic hydroxyl groups and an index of the water content, so that the phenolic hydroxyl groups of the end-capping agent and the phenolic hydroxyl groups of the bisphenol A complement each other, to block tendency of ring formation of small molecules. According to the extent of reaction and curve of the phenolic hydroxyl groups, actual end-capping technology breakthroughs are achieved, and the content of small molecules of the polysulfone resin is significantly reduced.

In later stage of the reaction, the present disclosure employs the end-capping agent B having activity slightly stronger than the bisphenol A, such as:

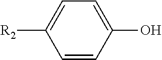

where R₂=—NH₂, —NHCH₃, —NHCOCH₃ and other electron-donating groups, to achieve rapid end-capping and stabilize the molecular weight in the later stage of the reaction, for example:

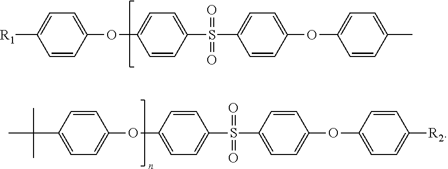

In the later stage of reaction, the speed of adding the end-capping agent B is controlled according to the molecular weight of the reaction system, to realize rapid end-capping, improve stability of the molecular weight, and reduce a distribution index of the molecular weight.

In some embodiments, the temperature of the polymerization reaction may be, for example, 150-200° C., 160-200° C., 150-180° C., such as 150° C., 160° C., 170° C., 180° C., 190° C., and 200° C. In some embodiments, the solvent is N,N-dimethylformamide, and the temperature of the polymerization reaction is 150°° C.-155° C. In some embodiments, the solvent is N,N-dimethylacetamide, and the temperature of the polymerization reaction is 160° C.-165° C. In some embodiments, the solvent is N-methyl pyrrolidone, and the temperature of the polymerization reaction is 190° C.-200° C.

Some embodiments of the present disclosure further provide polysulfone prepared by the above method.

Some embodiments of the present disclosure further provide use of the polysulfone in filter membranes.

In some embodiments, the filter membrane includes one of a hollow fiber membrane, a flat sheet membrane, an ion exchange membrane, and a semipermeable membrane.

The present disclosure overcomes the shortcomings in the prior art. The present disclosure provides a preparation method for double-end-capped polysulfone, in which by adding the end-capping agent A having lower activity than the bisphenol A in the early stage of the reaction, the part of polymers having a low molecular weight in a final product is reduced, so that the mechanical property, the heat resistance, the thermal stability, etc. of the product are improved. When the reaction is about to end, the end-capping agent B having higher activity than the bisphenol A is added, so as to achieve rapid end-capping and control the molecular weight, so that the performance of different batches of products is more stable, and the method is more suitable for the field of preparation of hollow fiber membranes.

1. In the present disclosure, by studying ring-forming mechanism of small molecules in the early stage of polysulfone polymerization, an end-capping measure is taken in the early stage of the reaction, so as to reduce probability of formation of ring dimers in principle. Thus, by screening the reaction activity, contents of the ring dimers and the small-molecular polymers in the product are reduced by adding the end-capping agent A in the early stage. When a proportion of a part of the polymer with a low molecular weight during use is too high, the mechanical property, the heat resistance and the thermal stability of the polysulfone resin are all reduced.

2. The present disclosure finds that the presence of water seriously affects proceeding of nucleophilic substitution reaction, then it is found that during the reaction, the duration of the salt forming reaction is about 3-6 h, and the duration for adding the end-capping agent A is 2-4 h. Within the first 1 h, the water content in the reaction system is controlled within the range of 1.0-1.5%, and the amount of the end-capping agent A added is about 45%- 60% of a total supplementation amount during the reaction. Within 2-3 h of the reaction, the water content in the reaction system is controlled within the range of 0.45-0.65%, and the amount of the end-capping agent A required to be added is about 30%- 40% of the total supplementation amount. Within 3-4 h, the water content in the reaction system is controlled within the range of 0.25-0.35%, and the amount of the end-capping agent A required to be added is about 8%-20% of the total supplementation amount. By this end-capping method, it may be achieved that a content of small molecular weight polysulfone is 0.9-1.5 wt %. Experiments find that when the water content of raw materials and solvent is less than 0.1%, the end-capping technology can be better realized.

3. The present disclosure, by using excess 4,4′-dichlorodiphenyl sulfone, can effectively reduce the content of phenolic hydroxyl groups in the product, so that the product is more stable during use, and is not prone to oxidation or yellowing.

4. In the present disclosure, by studying the mechanism that a too high halogen element content in the later stage of the polysulfone polymerization causes possible generation of harmful substances during combustion of the product and lack of control means between different batches, resulting in insufficient stability, adopts a double-end-capping measure in the later stage of the reaction, so as to reduce probability of generation of end group halogen in principle. Thus, through the screening of reaction activity of the end-capping agent group, the end-capping agent B is used and may react with 4,4′-dichlorodiphenyl sulfone in the reaction system to achieve rapid end-capping, so that molecular weight distribution of the final product is narrower, the molecular weight distribution is controlled at 63000-66000, and PDI is controlled within 1.0-2.0. The performance of different batches is more stable, and the method may be applied to the field of water treatment membranes, such as preparation of hollow fiber membranes. By means of technical verification, stability of a polysulfone casting solution of the present disclosure is improved from 0.5 days to 30 days, a water flux of a polysulfone membrane is improved from 2.6 L/min to 3.5 L/min, an aperture ratio reaches 95% or more, a membrane wall has a uniform thickness and is elastic, and yield of membrane finished products is improved from 80% of the conventional process to 95%. Membrane filaments are tough and elastic, and have good bending resistance, without indentation. The present disclosure breaks the overseas long-term technology monopoly, and achieves an international advanced technical level.

The present disclosure is further described below in combination with examples.

### EXAMPLES

### Example 1 Preparation of Double-End-Capped Polysulfone

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-hydroxyacetophenone was added according to a water content in a reaction system. Within the first 1 h, the water content in the reaction system was tested to be 1.0235%, and 6.09 g of p-hydroxyacetophenone was added during the reaction. Within 2-3 h, the water content in the reaction system was tested to be 0.44568%, and 3.43 g of p-hydroxyacetophenone needed to be added. Within 3-4 h, the water content in the reaction system was tested to be 0.29324%, and 0.90 g of p-hydroxyacetophenone needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L p-aminophenol was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Example 2 Preparation for Double-End-Capped Polysulfone

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-nitrophenol was added according to a water content in a reaction system. Within the first 1 h, the water content in the reaction system was tested to be 1.13400%, and 5.55 g of p-nitrophenol was added during the reaction. Within 2-3 h, the water content in the reaction system was tested to be 0.53251%, and 3.64 g of p-nitrophenol needed to be added. Within 3-4 h, the water content in the reaction system was tested to be 0.30511%, and 1.38 g of p-nitrophenol needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L p-methylaminophenol was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Example 3 Preparation for Double-End-Capped Polysulfone

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-hydroxybenzenesulfonic acid was added according to a water content in a reaction system. Within the first 1 h, the water content in the reaction system was tested to be 1.03460%, and 7.70 g of p-hydroxybenzenesulfonic acid was added during the reaction. Within 2-3 h, the water content in the reaction system was tested to be 0.48921%, and 4.14 g of p-hydroxybenzenesulfonic acid needed to be added. Within 3-4 h, the water content in the reaction system was tested to be 0.28911%, and 1.52 g of p-hydroxybenzenesulfonic acid needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L N-(4-hydroxyphenyl) acetamide was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Comparative Example 1 (End-Capping Agent: End-Capping Agent A/End-Capping Agent A)

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-hydroxyacetophenone was added according to a water content in a reaction system. Within the first 1 h, the water content in the reaction system was tested to be 1.13541%, and 5.42 g of p-hydroxyacetophenone was added during the reaction. Within 2-3 h, the water content in the reaction system was tested to be 0.55643%, and 3.43 g of p-hydroxyacetophenone needed to be added. Within 3-4 h, the water content in the reaction system was tested to be 0.32144%, and 1.39 g of p-hydroxyacetophenone needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L p-hydroxyacetophenone was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Comparative Example 2 (End-Capping Agent: End-Capping Agent B/End-Capping Agent B)

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-aminophenol was added according to a water content in a reaction system. Within the first 1 h, the water content in the reaction system was tested to be 1.24381%, and 3.83 g of p-aminophenol was added during the reaction. Within 2-3 h, the water content in the reaction system was tested to be 0.61512%, and 2.99 g of p-aminophenol needed to be added. Within 3-4 h, the water content in the reaction system was tested to be 0.30131%, and 1.49 g of p-aminophenol needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N, N-dimethylacetamide solution with 1.8 mol/L p-aminophenol was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Comparative Example 3 (End-Capping Agent: End-Capping Agent B/End-Capping Agent A)

In a 100 L reaction kettle equipped with condensation, N₂ protection, stirring, water separator, and temperature sensing, 4.34 Kg of bisphenol A, 5.74 Kg of 4,4′-dichlorodiphenyl sulfone and 2.90 Kg of K₂CO₃ were added to 47 L of N,N-dimethylacetamide. Room temperature was gradually increased to 120° C. P-aminophenol was added according to a water content in a reaction system. Within the first 1 h, the water content in the reaction system was tested to be 1.04736%, and 4.77 g of p-aminophenol was added during the reaction. Within 2-3 h, the water content in the reaction system was tested to be 0.50413%, and 2.58 g of p-aminophenol needed to be added. Within 3-4 h, the water content in the reaction system was tested to be 0.31421%, and 0.90 g of p-aminophenol needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L p-hydroxyacetophenone was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Comparative Example 4 (End-Capping Agent: End-Capping Agent A/End-Capping Agent B, Raw Material Water Content>5%)

In a 100 L reaction kettle equipped with condensation, N₂ protection, stirring, water separator, and temperature sensing, 4.34 Kg of bisphenol A (water content>5%), 5.74 Kg of 4,4′-dichlorodiphenyl sulfone (water content>5%) and 2.90 Kg of K₂CO₃ (water content>5%) were added to 47 L of N,N-dimethylacetamide (water content>5%). Room temperature was gradually increased to 120° C. Within the first 1 h, the water content in a reaction system was tested to be 5.04250%, and 5.38 g of p-hydroxyacetophenone was added during the reaction. Within 2-3 h, the water content in the reaction system was tested to be 3.30578%, and 3.78 g of p-hydroxyacetophenone needed to be added. Within 3-4 h, the water content in the reaction system was tested to be 1.50424%, and 1.20 g of p-hydroxyacetophenone needed to be added. Meanwhile, an outflow liquid was extracted at a rate of 5 L/h for 4 h during the reaction (a water content in a final extraction liquid was lower than 0.5%). The temperature continued to be raised to 160° C. which was maintained for 6 h. After 160° C. was maintained for 6 h, 5 L of N,N-dimethylacetamide solution with 1.8 mol/L p-aminophenol was added (completing the addition within half an hour). 15 L of N,N-dimethylacetamide was added to dilute reaction polymerization solution and reduce the temperature to 110° C. Then, the reaction polymerization solution was filtered 3 times, and the polymerization solution was precipitated, crushed, and filtered in 100 L of mixed solution of water and alcohol (mixing ratio V_{water}:Vₑₜₕₐₙₒₗ=1:1). Then, crushed product was boiled in 100° C. deionized water (60 L/time) for three times, and then boiled in 70° C. ethanol (60 L/time) for three times. The product was dried at 145±5° C. for 12 h to obtain white powder polysulfone product.

### Comparative Example 5 (End-Capping Agent: Bisphenol S-P-Cresol)

In a 100 L reaction kettle equipped with condensation, N₂ protection, stirring, water separator, and temperature sensing, 4.3 Kg of 4,4′-dichlorodiphenyl sulfone, 6.6 Kg of bisphenol A, 5.2 Kg of potassium carbonate, 35 Kg of solvent N,N-dimethylacetamide (DMAC), and 15 Kg of p-xylene were added. Nitrogen was introduced to enable pressure inside the kettle to reach ≥0.00 MPa. After three times of nitrogen replacement, nitrogen was introduced to reach normal pressure and then react. Nitrogen protection was carried out throughout polymerization reaction. Treatment was carried out at 150° C. for 2 h. During this period, a total mass of 42 g of reformulated end-capping agent bisphenol S and p-cresol (a mass ratio of the two was 5:5) and 4.6 kg of dichlorodiphenyl sulfone were dissolved in 35 Kg of DMAC, and added to the reaction kettle at a uniform speed. After all xylene was distilled off, temperature was raised to 162° C., and polymerization was continued for 10 h. Solid content was maintained at 22-30%, and when viscosity in the kettle reached 6000 centipoise, the reaction was ended. After the reaction was ended, polymerization solution was slowly poured into water to completely precipitate polysulfone materials, and after being mechanically crushed into powder, the powder was boiled at high temperature for many times, and purified polysulfone materials were dried to obtain a powdery product.

### Comparative Example 6 (End-Capping Agent: 4-Phenylphenol)

In a 100 L reaction kettle equipped with condensation, N₂ protection, stirring, water separator, and temperature sensing, 35.357 Kg of bis (4-chlorophenyl)sulfone, 30.036 Kg of bis (4-hydroxyphenyl) sulfone, 6.54 g of 4-phenylphenol and 57.993 Kg of diphenyl sulfone were mixed in a polymerization kettle provided with a stirrer, a nitrogen inlet pipe, a thermometer and a condenser mounted with a receiver at a front end. Temperature was raised to 180° C. while introducing nitrogen into the system. After 17.092 Kg of potassium carbonate was added to a resulting mixed solution, the temperature was gradually increased to 288° C., so that reaction was further carried out at 288° C. for 4 hours. Then, the resulting reaction mixture solution was cooled to room temperature, solidified, finely pulverized, and then precipitated and filtered using hot water as well as a mixed solvent of acetone and methanol, whereby cleaning was performed several times. Resulting solid was heated and dried at 150° C., thereby obtaining aromatic polysulfone.

Products prepared in Examples 1-3 and Comparative Examples 1-6 were tested according to an existing test method, and test data of the products are as shown in Table 1 below:

TABLE 1
Test of Product Property

| | Type of | Content of | Content | | | |
|---|---|---|---|---|---|---|
| | End- | Chlorine | of Ring | | | |
| | capping | End Group | Dimer | | | |
| Product | Agent | (mg/Kg) | (wt %) | Mw | Mn | PDI |
| Example 1 | A-B | 534 | 0.98 | 63482 | 42041 | 1.51 |
| Example 2 | A-B | 585 | 1.05 | 64130 | 41642 | 1.54 |
| Example 3 | A-B | 604 | 1.03 | 65831 | 41665 | 1.58 |
| Comparative | A-A | 983 | 0.99 | 69248 | 42224 | 1.64 |
| Example 1 | | | | | | |
| Comparative | B-B | 564 | 1.54 | 53577 | 30280 | 1.77 |
| Example 2 | | | | | | |
| Comparative | B-A | 1021 | 1.34 | 55178 | 31958 | 1.73 |
| Example 3 | | | | | | |
| Comparative | A-B | 1645 | 3.45 | 65643 | 22051 | 2.98 |
| Example 4 | | | | | | |
| (raw-material | | | | | | |
| water content | | | | | | |
| >5%) | | | | | | |
| Comparative | Bisphenol | 1643 | 1.15 | 78740 | 41216 | 1.91 |
| Example 5 | S-p-cresol | | | | | |
| Comparative | 4- | 1025 | 2.34 | 78213 | 35021 | 2.23 |
| Example 6 | phenylphenol | | | | | |

A method for testing a content of chlorine end groups is as follows: firstly, testing a total chlorine content (N₀) of the polysulfone resin by ion chromatography, then weighing 5 g of sample, adding 1 L of mixed solvent of methanol and water (Vₘₑₜₕₐₙₒₗ:V_{water}=1:1), heating and refluxing to extract residual chloride ions in a trace amount of by-product NaCl in the resin, and after filtration, testing a chlorine content in filtrate by the ion chromatography, and back-calculating a free chlorine content (N₁) in the resin. The content of chlorine end groups of the polysulfone resin is N=N₀−N₁. A substitution ratio of the content of chlorine end groups represents a ratio of a difference between the content of chlorine end groups of the end-capped polysulfone resin and the content of chlorine end groups of the end-uncapped polysulfone resin in the same set of experiments to the content of chlorine end groups of the end-uncapped polysulfone resin.

A method for testing a molecular weight is as follows: ring dimer content, Mn, Mw and PDI are analyzed and tested by gel permeation chromatography (GPC). Certainly, the above contents are only for preferred examples of the present disclosure, and cannot be considered as limitation to the scope of the embodiments and examples of the present disclosure. The present disclosure is not merely limited to the above examples, and all equivalent changes, improvements, etc. made by those ordinarily skilled in the art within the substantive scope of the present disclosure shall belong to the patent scope of protection of the present disclosure.

### INDUSTRIAL APPLICABILITY

In the preparation method for double-end-capped polysulfone provided in the present disclosure, by adding the end-capping agent A having lower activity than the bisphenol A in the early stage of the reaction, the part of polymer having a low molecular weight in a final product is reduced, so that the mechanical property, the heat resistance, the thermal stability, etc. of the product are improved. When the reaction is about to end, the end-capping agent B having higher activity than the bisphenol A is added, so as to achieve rapid end-capping and control the molecular weight, so that the performance of different batches of products is more stable. The method is more suitable for the field of preparation of hollow fiber membranes, and has excellent applicability and a good application prospect.

1. A preparation method for double-end-capped polysulfone, wherein bisphenol A and 4,4′-dichlorodiphenyl sulfone are used as reaction monomers, an end-capping agent A having lower activity than the bisphenol A, a salt forming agent and a solvent are added for performing reaction until a molecular weight reaches a target molecular weight, an end-capping agent B having higher activity than the bisphenol A is added to continue the reaction, and a post-treatment is performed after the reaction is completed to obtain the double-end-capped polysulfone.

2. The preparation method for double-end-capped polysulfone according to claim 1, comprising following steps:
(1) polymerization reaction: using bisphenol A and 4,4′-dichlorodiphenyl sulfone as the reaction monomers, adding the salt forming agent and the solvent to first perform a salt forming reaction, wherein during the reaction, adding the end-capping agent A having lower activity than bisphenol A according to a phenolic hydroxyl group content and/or a water content in a reaction system, then heating up to perform the polymerization reaction, when the molecular weight reaching the target molecular weight, adding the end-capping agent B having higher activity than the bisphenol A to continue the reaction, and after the reaction being completed, obtaining a polymerization solution; and
(2) post-treatment: diluting the polymerization solution and then filtering the diluted polymerization solution, then precipitating, crushing, and filtering the filtered polymerization solution, and then washing and drying a crushed product to obtain the double-end-capped polysulfone.

3. The preparation method for double-end-capped polysulfone according to claim 2, wherein a temperature of the salt forming reaction is 80-120° C., and reaction duration is 3-6 h; a temperature of the polymerization reaction is 160-200° C., reaction duration is 2-8 h, and the reaction is continued for 20-40 min after adding the end-capping agent B having activity higher than bisphenol A.

4. The preparation method for double-end-capped polysulfone according to claim 2, wherein a temperature of the salt forming reaction is 80-120° C., and reaction duration is 3-6 h; a temperature of the polymerization reaction is 150-200° C., reaction duration is 2-8 h, and the reaction is continued for 20-40 min after adding the end-capping agent B having activity higher than bisphenol A.

5. The preparation method for double-end-capped polysulfone according to claim 2, wherein during the salt forming reaction, duration for adding the end-capping agent A is 2-4 h, as follows:
within a first 1 h, the water content in the reaction system is controlled within a range of 1.0-1.5%, and an amount of the end-capping agent A added is 45-60% of a total mass of the end-capping agent A;
within 2-3 h of the reaction, the water content in the reaction system is controlled within a range of 0.45-0.65%, and an amount of the end-capping agent A added is 30-40% of the total mass of the end-capping agent A; and
within 3-4 h of the reaction, the water content in the reaction system is controlled within a range of 0.25-0.35%, and an amount of the end-capping agent A added is 8-20% of the total mass of the end-capping agent A.

6. The preparation method for double-end-capped polysulfone according to claim 1, wherein a molar ratio of 4,4′-dichlorodiphenyl sulfone to bisphenol A is (1.015:1)-(1.2:1), and a water content of both 4,4′-dichlorodiphenyl sulfone and bisphenol A is less than 0.1%.

7. The preparation method for double-end-capped polysulfone according to claim 1, wherein the solvent is one of N,N-dimethylformamide, N,N-dimethylacetamide, N-methyl pyrrolidone or sulfolane, and a water content of the solvent is less than 0.1%.

8. The preparation method for double-end-capped polysulfone according to claim 1, wherein a molar ratio of the salt forming agent to bisphenol A is (1.01:1)-(1.2:1), the salt forming agent is one of K₂CO₃, KHCO₃, Na₂CO₃ or NaHCO₃, and a water content of the salt forming agent is less than 0.1%.

9. The preparation method for double-end-capped polysulfone according to claim 1, wherein the end-capping agent A is one of p-nitrophenol, p-hydroxybenzenesulfonic acid or p-hydroxyacetophenone.

10. The preparation method for double-end-capped polysulfone according to claim 1, wherein the end-blocking agent B is one of p-aminophenol, p-methylaminophenol or N-(4-hydroxyphenyl) acetamide.

11. The preparation method for double-end-capped polysulfone according to claim 1, wherein a molar ratio of the end-capping agent A to bisphenol A is (0.003:1)-(0.005:1); and a molar ratio of the end-blocking agent B to bisphenol A is (0.003:1)-(0.006:1).

12. A polysulfone, prepared by the method according to claim 1.

13. Use of the polysulfone according to claim 12 in a filter membrane.

14. The use according to claim 13, wherein the filter membrane comprises one of a hollow fiber membrane, a flat sheet membrane, an ion exchange membrane, and a semipermeable membrane.

15. The preparation method for double-end-capped polysulfone according to claim 3, wherein during the salt forming reaction, duration for adding the end-capping agent A is 2-4 h, as follows:
within a first 1 h, the water content in the reaction system is controlled within a range of 1.0-1.5%, and an amount of the end-capping agent A added is 45-60% of a total mass of the end-capping agent A;
within 2-3 h of the reaction, the water content in the reaction system is controlled within a range of 0.45-0.65%, and an amount of the end-capping agent A added is 30-40% of the total mass of the end-capping agent A; and
within 3-4 h of the reaction, the water content in the reaction system is controlled within a range of 0.25-0.35%, and an amount of the end-capping agent A added is 8-20% of the total mass of the end-capping agent A.

16. The preparation method for double-end-capped polysulfone according to claim 2, wherein a molar ratio of 4,4′-dichlorodiphenyl sulfone to bisphenol A is (1.015:1)-(1.2:1), and a water content of both 4,4′-dichlorodiphenyl sulfone and bisphenol A is less than 0.1%.

17. The preparation method for double-end-capped polysulfone according to claim 2, wherein the solvent is one of N,N-dimethylformamide, N,N-dimethylacetamide, N-methyl pyrrolidone or sulfolane, and a water content of the solvent is less than 0.1%.

18. The preparation method for double-end-capped polysulfone according to claim 2, wherein a molar ratio of the salt forming agent to bisphenol A is (1.01:1)-(1.2:1), the salt forming agent is one of K₂CO₃, KHCO₃, Na₂CO₃ or NaHCO₃, and a water content of the salt forming agent is less than 0.1%.

19. The preparation method for double-end-capped polysulfone according to claim 2, wherein the end-capping agent A is one of p-nitrophenol, p-hydroxybenzenesulfonic acid or p-hydroxyacetophenone.

20. The preparation method for double-end-capped polysulfone according to claim 2, wherein the end-blocking agent B is one of p-aminophenol, p-methylaminophenol or N-(4-hydroxyphenyl) acetamide.
